(19) United States
(12) Patent Application Publication
(10) Pub. No.: US 2008/0199035 A1
(43) Pub. Date: Aug. 21, 2008

(54) In-Ear Phone

(75) Inventors: Thomas Flechel, Etterbeek (BE); Julien Bergere, Brussels (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/917,170

(22) PCT Filed: Jun. 14, 2006
(86) PCT No.: PCT/IB06/51905

§ 371 Date: Dec. 11, 2007

(30) Foreign Application Priority Data
Jun. 15, 2005 (EP) 05105266.0

(51) Int. Cl. H04R 1/10

(52) U.S. Cl. 381/380

(57) ABSTRACT

An in-ear phone (1) comprising a speaker driver (2) which is insertable into an auditory canal (3), wherein the direction of the axis (a1) of the speaker driver (2) is substantially perpendicular to the direction of the longitudinal axis (a2) of the auditory canal (3) in a mounted position of the in-ear phone (1), in which mounted position the speaker driver (2) is inserted into the auditory canal (3), and wherein a sound emanating area (4) of the speaker driver (2) extends at least partially directly into the auditory canal (3).

### FIELD OF THE INVENTION

The invention relates to an in-ear phone comprising a speaker driver which is insertable into an auditory canal, wherein the direction of the axis of the speaker driver is substantially perpendicular to the direction of the longitudinal axis of the auditory canal in a mounted position of the in-ear phone, in which mounted position the speaker driver is inserted into the auditory canal.

### BACKGROUND OF THE INVENTION

In-ear phones (also known as “canal-phones”) are placed inside the auditory canal of a user's ear, positioning them closer to the eardrum than other types of headphones.

An in-ear phone as mentioned in the first paragraph is known from document U.S. Pat. No. 6,683,965 B1. The essential features of the embodiment disclosed in the U.S. Pat. No. 6,683,965 B1 are illustrated schematically in FIGS. 1-3.

FIG. 1 shows an in-ear phone according to the state of the art in an operating position.

FIG. 2 shows an equivalent circuit diagram of the in ear phone of FIG. 1.

FIG. 3 shows a frequency response of the in-ear phone of FIG. 1.

The in-ear phone 1a according to the state of the art comprises a speaker driver 2 for sound reproduction and a housing 6′ covering the speaker driver 2. The housing 6′ is oval shaped to enable an inserting into the auditory canal 3 of a user's ear. The direction of the axis a1 of the speaker driver 2 is substantially perpendicular to the axis a2 of the auditory canal 3 when the housing 6′ is inserted into the auditory canal 3. The auditory canal 3, part of the ear, is a tube running from the outer ear to the middle ear. It ends at the eardrum 3′. The term longitudinal axis a2 of the auditory canal 3 means a curve or line respectively in the longitudinal direction of the auditory canal 3. The axis a2 essentially constitutes an axis of symmetry of the auditory canal 3. Depending on the form of the auditory canal 3 the axis a2 is not necessarily a straight line and may also be curved according to the characteristics of the auditory canal 3. The speaker 2 is completely located within the housing 6′. Sound emitted by a sound emanating area 4 of the speaker driver 2, is due to the construction of the in-ear phone 1a, not emanated directly into the auditory canal 3. First the sound emanated by the speaker driver 2 has to pass a volume A constituted by the interior of the housing 6′. After that the sound waves have to pass through an opening B at the front of the housing 6′ to get into the auditory canal 3. It is a disadvantage of the known in-ear phone that the reproduction of high frequencies is not optimal, since the volume A and the opening B constitute a low-pass filter for sound waves produced by the speaker driver 2.

The phenomenon of constituting a low-pass filter with the known in-ear phone 1a is illustrated in FIG. 2. In electroacoustics, a volume is represented electrically with a capacitor, and a hole with a coil. So the volume A in front of the speaker driver 2 coupled with the hole B and the volume of the auditory canal 3 is represented by an electrical circuit 1a′ corresponding to a low-pass filter.

FIG. 3 shows a frequency response of the in-ear phone 1a. As one can clearly see in FIG. 3 it is a major disadvantage of the known embodiment that frequencies higher than 10000 Hz are not reproduced very well.

### OBJECT AND SUMMARY OF THE INVENTION

It is an object of the invention to provide an in-ear phone of the type mentioned in the first paragraph, which obviates the drawbacks described hereinbefore.

To achieve the object described above, characteristic features according to the invention are provided with an in-ear phone according to the invention, so that an in-ear phone according to the invention can be characterized as follows:

In-ear phone comprising a speaker driver being insertable into an auditory canal, wherein the direction of the axis of the speaker driver is substantially perpendicular to the direction of the longitudinal axis of the auditory canal in a mounted position of the in-ear phone, in which mounted position the speaker driver is inserted into the auditory canal, and wherein a sound emanating area of the speaker driver extends at least partially directly into the auditory canal.

The provision of the characteristic features according to the invention creates the advantage that sound is emanated directly into the auditory canal. Thus a high quality reproduction of high frequencies is achieved.

It is advantageous when the in-ear phone comprises means for sealing the auditory channel. Thereby the advantage is achieved that external noise and disturbances can be inhibited very effectively.

It is further advantageous, when the speaker driver is partially covered by a housing. This measure provides the advantage that the driver can be positioned very easily in the auditory canal and that a good acoustical function is achieved.

Yet another preferred embodiment of the invention is provided with an in-ear phone, wherein the housing seals the auditory canal in an operating position of the in-ear phone. Thus the advantage is provided that producing of the in-ear phone is simplified since the sealing function and the function of positioning the speaker driver as well as providing a good acoustical function is realized by means of one item of hardware.

Finally it is advantageous, when the area of the sound emanating area is larger than an area of a cross section of the auditory canal, which cross section is essentially parallel to the eardrum. This measure provides the advantage of an excellent reproduction of sound, since the sound emanating area of the speaker driver is enlarged very much with regard to the eardrum.

These and other aspects of the invention are apparent from and will be elucidated with reference to the embodiments described hereinafter.

### BRIEF DESCRIPTION OF THE DRAWINGS

The invention will be described in greater detail hereinafter, by way of non-limiting examples, with reference to the embodiments shown in the drawings.

FIG. 4 shows a first embodiment of an in-ear phone according to the invention in an operating position.

FIG. 5 shows a detail of FIG. 4 in an enlarged view.

FIG. 6 shows a frequency response of an in-ear phone according to the invention.

FIG. 7 shows a second embodiment of an in-ear phone according to the invention in an operating position.

The figures are schematically drawn and not true to scale, and identical reference numerals in different figures refer to corresponding elements. It will be clear to those skilled in the art that alternative but equivalent embodiments of the invention are possible without deviating from the true inventive concept, and that the scope of the invention will be limited by the claims only.

### DESCRIPTION OF EMBODIMENTS

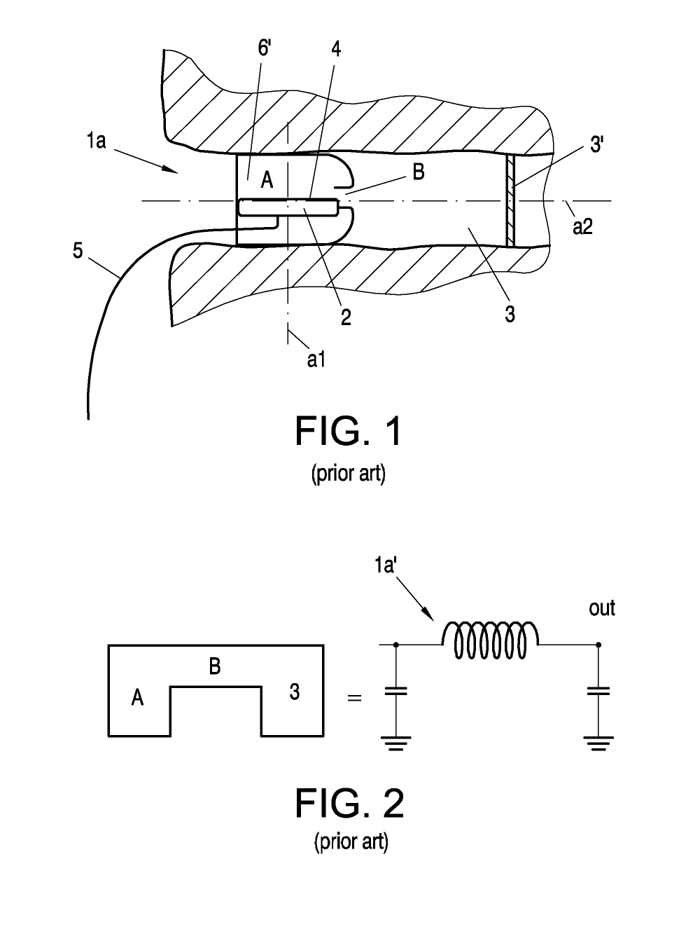

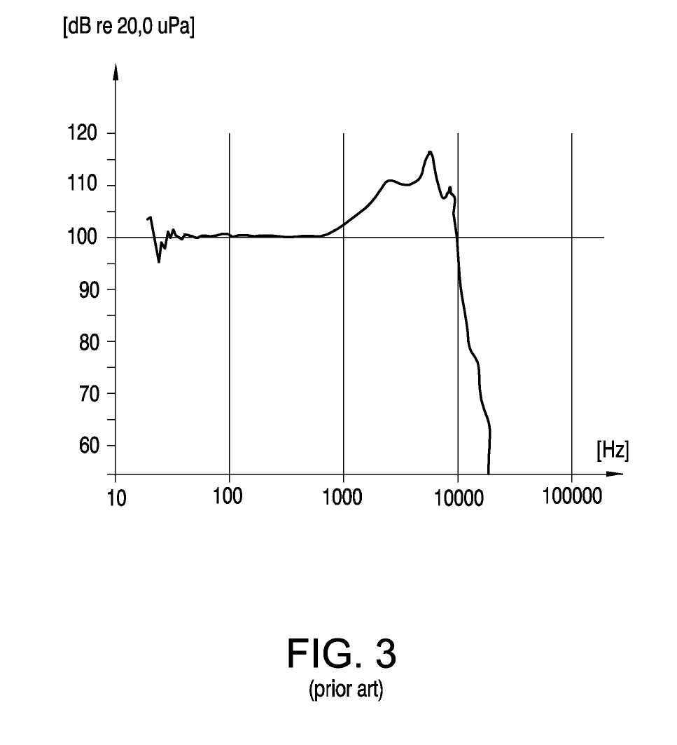

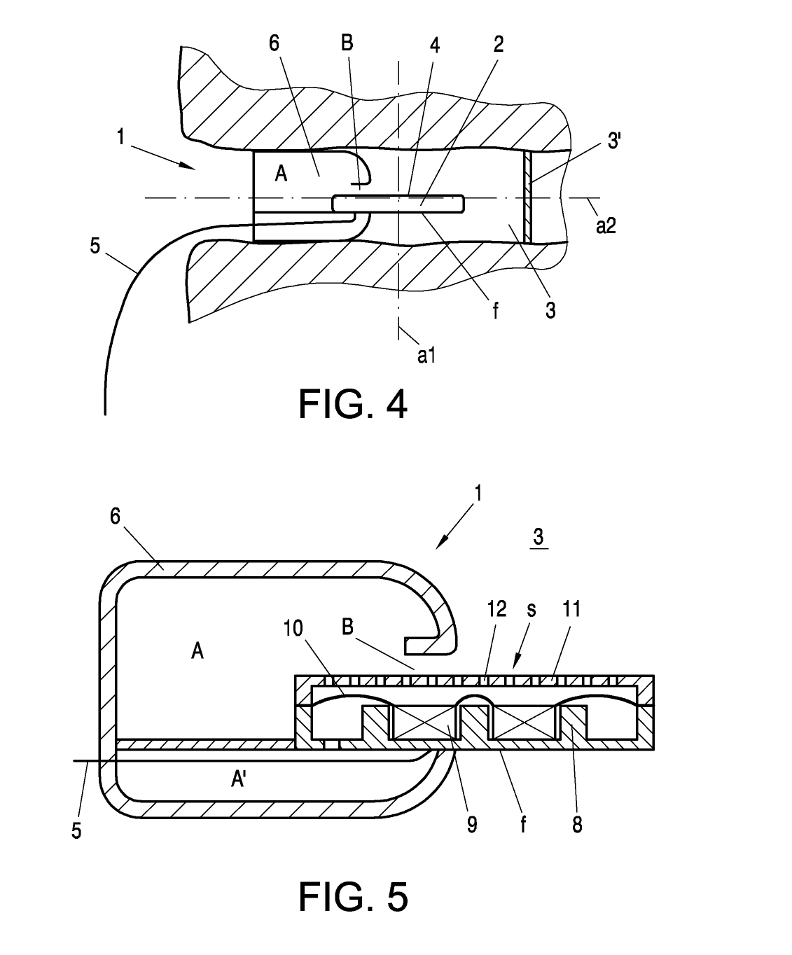

FIG. 4 shows an in-ear phone 1 according to the invention. The in-ear phone 1 comprises a speaker driver 2. The speaker driver 2 is of an oval form and disk-shaped. Alternatively, the speaker driver 2 may be of a rectangular or a square shape as well. The speaker driver 2 can be inserted into an auditory canal 3 of a user's ear. When the in-ear phone 1 is positioned in its operating position within the auditory canal 3, the direction of the axis a1 of the speaker driver 2 is substantially perpendicular to the direction of a longitudinal axis a2 of the auditory canal 3. This means that the plane of the sound emanating area 4 is substantially parallel to the axis a2 of the auditory canal 3.

According to a preferred embodiment of the invention the area of the sound emanating area 4 is larger than the area of a cross section of the auditory canal 3, which cross section is essentially parallel to the eardrum 3′. The measures mentioned in this paragraph achieve the advantage of a high quality sound reproduction, since the sound emanating area 4 is enlarged with regard to the eardrum 3′.

The particular orientation of the speaker driver 2 provides the advantage that an applicator for the speaker driver 2 can be made narrow enough so as to fit into a wide variety of ear sizes. A further advantage of the particular orientation of the speaker driver 2 is that a speaker driver 2 with a very large sound emanating area 4 can be inserted into the auditory canal 3. It is still further an advantage of the particular orientation of the speaker driver 2 that disturbances of sound reproduction caused by resonances inside the auditory canal 3 are minimized.

In the operating position the sound emanating area 4 of the speaker driver 2 extends partially directly into the auditory canal 3. Particularly a front part f of the speaker driver 2 or the sound emanating area 4 extends into the auditory canal 3. This means that sound produced by the speaker driver 2 is emanated directly into the auditory canal 3. This offers the advantage that high frequencies can be reproduced with a high quality. Due to the fact that there is no additional chamber or volume respectively between the front part f of the sound emanating area 4 of the speaker driver 2 and the auditory canal 3, the constitution of a low-pass filter is avoided very effectively. According to the embodiment shown, half of the sound emanating area 4 is arranged directly in the auditory canal 3.

Further a cord 5 for supplying an audio signal from an external electronic device to the speaker driver 2 is provided. The external electronic device can for instance be a portable audio rendering device, e.g. a radio or CD-player or an MP3 player.

According to the embodiment shown, the in-ear phone 1 comprises means for sealing the auditory canal 3 from the space outside the ear. This sealing means for instance may be a housing 6 partially covering the speaker driver 2. The housing 6 can for instance be made of plastic. The housing 6 is of an oval shape. This offers the advantage that the in-ear phone 1 can be easily inserted into a user's auditory canal 3. The in-ear phone 1 according to the invention has an excellent isolation quality because the housing 6 acts as an earplug.

According to FIG. 5, which shows the in-ear phone 1 of FIG. 4 in more detail, the speaker driver 2 comprises a magnetic circuit 8 and a so-called voice coil 9 connected with a diaphragm 10.

When an electrical signal is applied to the voice coil 9 via the cord 5 connecting the in-ear phone 1 with the external electronic device, the voice coil 9 causes the diaphragm 10 to oscillate and to reproduce sound at the frequency of the applied electrical signal. On its sound emanating sides the speaker 2 comprises a front portion 11 which opposes the diaphragm 10. This front portion 11 has a plurality of through holes 12 through which sound waves emitted from the diaphragm 10 are made to pass. The front portion 11 constitutes the sound emanating area of the speaker driver 2, which is indicated by the reference number 4 in FIGS. 1, 4 and 7. The housing 6 comprises two volumes, one interior volume A communicating with the auditory canal 3 and a volume A′ separated from the volume A. The volume A′ constitutes a back volume for the speaker driver 2.

Furthermore, the housing 6 comprises an opening B connecting the interior volume A of the housing 6 with the volume of the auditory canal 3. This provides the advantage of a very good acoustic function. Preferably, the housing 6 comprises one or more small holes connecting the volume A and thus the auditory canal 3 with the space outside the ear to damp resonances within the auditory canal 3. The holes mentioned in the previous sentence are not shown in the figures.

In the embodiment shown there are still the two volumes A and 3 and the hole B but the sound emanated by the front part f of the sound emanating area 4 gets directly into the auditory canal 3, without passing the first volume A of the housing 6 and the hole B. This is an adequate measure to avoid the low-pass filter effect described above and to allow a high quality reproduction of high frequencies.

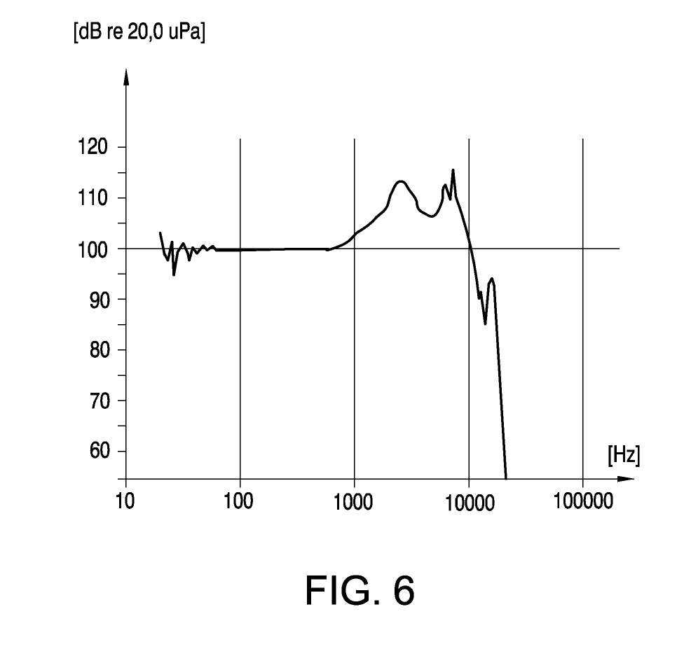

FIG. 6 shows a frequency response of the in-ear phone 1 according to the invention. As one can clearly see the reproduction of high frequencies in the range over 10000 Hz is improved significantly by means of the invention.

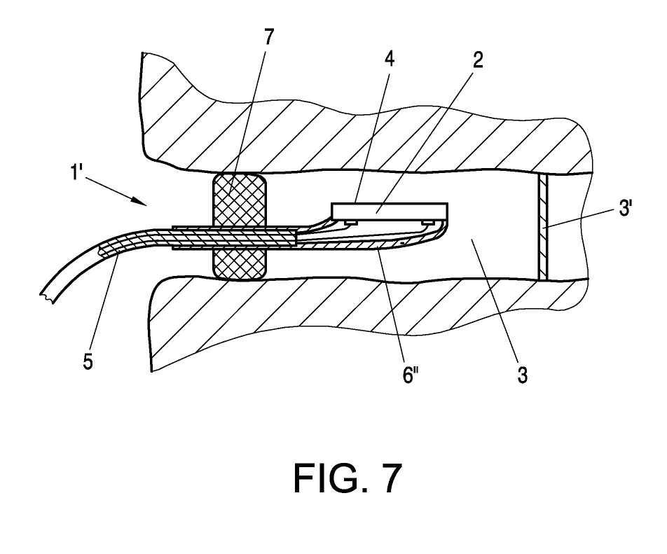

According to FIG. 7 the auditory canal 3 may also be sealed by means of a closing device 7, e.g. a stubble made of plastics or foamed or sponge material. According to the embodiment shown in FIG. 7 the in ear-phone 1′ comprises a housing 6″ in the form of a cover sheet creating a small back volume for the speaker driver 2. The housing 6″ traverses the closing device 7 and is held in its operating position inside the auditory canal 3 by means of the closing device 7. Further the part of the housing 6″ surrounding the speaker driver 2 is of an oval shape to perfectly fit in a user's auditory canal 3. According to this embodiment of the invention the whole sound emanating area 4 of the speaker 2 is arranged directly in the auditory canal 3.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The words “comprising” and “comprises”, and the like, do not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. (canceled)

2. The in-ear phone according to claim 6, further comprising means for sealing the auditory canal.

3. The in-ear phone according to claim 6, wherein the speaker is partially covered by a housing.

4. The in-ear phone according to claim 3, wherein the housing seals the auditory canal.

5. (canceled)

6. An in-ear phone having an operating position within an auditory canal of a user's ear, comprising a speaker positioned inside the auditory canal in the operating position, the speaker having an axis in a direction substantially perpendicular to a direction of a longitudinal axis of the auditory canal, the speaker further including a sound emanating area that extends at least partially into the auditory canal in the operating position and that has a plane being substantially parallel to the longitudinal axis of the auditory canal.

7. The in-ear phone according to claim 6, wherein the sound emanating area is enlarged with respect to an eardrum of the user's ear.

8. The in-ear phone according to claim 6, wherein the sound emanating area is arranged directly in the auditory canal.
